(19) United States
(12) Patent Application Publication
(10) Pub. No.: US 2014/0012619 A1
(43) Pub. Date: Jan. 9, 2014

(54) SYSTEMS AND METHODS FOR CUSTOMIZING CONTENT FEEDS

(71) Applicant: SALESFORCE.COM INC., San Francisco, CA (US)

(72) Inventors: Mrina Natarajan, San Mateo, CA (US); Samuel Sharaf, San Francisco, CA (US)

(21) Appl. No.: 13/938,112

(22) Filed: Jul. 9, 2013

Related U.S. Application Data
(60) Provisional application No. 61/669,420, filed on Jul. 9, 2012.

(51) Int. Cl. H04L 12/58

(52) U.S. Cl. CPC H04L 51/32
USPC 705/7.19; 709/206

(57) ABSTRACT

The technology disclosed relates to automated customization of content feeds in an online social environment. In particular, it relates to providing customized views of a feed by prioritizing feed items of the feed in accordance with on one or more metrics. The customized views can be configured to automatically provide ready access to information required at a given time, place or situation. Also, the one or more metrics can be based on engagement strength, interaction strength or location proximities of entities in the online social environment.

### RELATED APPLICATION

The application claims the benefit of U.S. provisional Patent Application No. 61/669,420, entitled, “System and Method for Analytics Driven Prioritization of Location Based Feeds,” filed on Jul. 9, 2012. The provisional application is hereby incorporated by reference for all purposes.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed inventions.

The technology disclosed relates to automated customization of content feeds in an online social environment. In particular, it relates to providing customized views of a feed by prioritizing feed items of the feed in accordance with on one or more metrics. The customized views can be configured to automatically provide ready access to information required at a given time, place or situation. Also, the one or more metrics can be based on engagement strength, interaction strength or location proximities of entities in the online social environment.

Social networking has revolutionized the way entities communicate and share information with each other. Online social environments are communities of entities that include users, groups and organizations. These entities share interests and activities and are interested in exploring the interests and activities of other entities. Many social environments provide a collection of various ways for entities to interact, such as feeds, posts, chat, messaging, email, video, voice chat, file sharing, blogging and discussion groups. Social network environments also typically provide tools and communication infrastructures for organizing and managing social networks.

As the volume of information flowing in the online social environments continues to increase, the need for automated tools that can assist entities in receiving information valuable to them also increases. The information overload created by multitude of information sources makes it difficult for entities to know what piece of information is more suitable, relevant or appropriate to their needs and desires. Also, a substantial portion of entities' web surfing time is spent on separating key information from noise.

Accordingly, it is desirable to provide systems and methods that offer a flexible approach to content prioritization and customization. An opportunity arises to shift the burden of information filtering from the entities to automated systems and methods that can prioritize information based on entity preferences and can further automatically present it to the entities at the appropriate times, places or situations. Improved entity experience and engagement and higher customer satisfaction and retention may result.

### SUMMARY

The technology disclosed relates to automated customization of content feeds in an online social environment. In particular, it relates to providing customized views of a feed by prioritizing feed items of the feed in accordance with on one or more metrics. The customized views can be configured to automatically provide ready access to information required at a given time, place or situation. Also, the one or more metrics can be based on engagement strength, interaction strength or location proximities of entities in the online social environment.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 shows one implementation of a feed customization environment.

FIG. 2 is an example of one implementation of an event-based schema.

FIG. 3 illustrates one implementation of an event-based customized view.

FIG. 4 shows one implementation of a plurality of tables that can be used for target entity-based prioritization.

FIG. 5 illustrates one implementation of a target entity-based customized view.

FIG. 6 is one implementation of a plurality of tables that can be used for feed posting entities-based feed prioritization.

FIG. 7 illustrates one implementation of a feed posting entities-based customized view.

FIG. 8 illustrates a flowchart of one implementation for providing sales related content to a salesman for a sales meeting.

FIG. 9 shows a flowchart of one implementation for streamlining social feeds in an online social environment based on a target entity.

FIG. 10 is a flow chart of one implementation for streamlining social feeds in an online social environment based on feed posting entities.

FIG. 11 is a block diagram of an example computer system for feed customization and streamlining.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

The technology disclosed relates to automated streamlining of content feeds in an online social environment. In particular, it relates to filtering out feed items that are valuable to an entity based on one or more metrics. The filtered feed items can appear in the top of the content feed such that the entity can consume the information included the filtered feed items before any other information. Also, the one or more metrics can be based on engagement strength, interaction strength or location proximities of entities in the online social environment.

Examples of systems, apparatus, and methods according to the disclosed implementations are described in a “sales” context. The examples of sales events such as sales meetings scheduled by salesmen are being provided solely to add context and aid in the understanding of the disclosed implementations. In other instances, events may include technology related events, business driven events, etc. Other applications are possible, such that the following examples should not be taken as definitive or limiting either in scope, context or setting. It will thus be apparent to one skilled in the art that implementations may be practiced in or outside the “sales” context.

The technology disclosed relates to customizing and streamlining content feeds for use in a computer-implemented system. The described subject matter can be implemented in the context of any computer-implemented system, such as a software-based system, a database system, a multi-tenant environment, or the like. Moreover, the described subject matter can be implemented in connection with two or more separate and distinct computer-implemented systems that cooperate and communicate with one another. One or more implementations may be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

### Feed Customization Environment

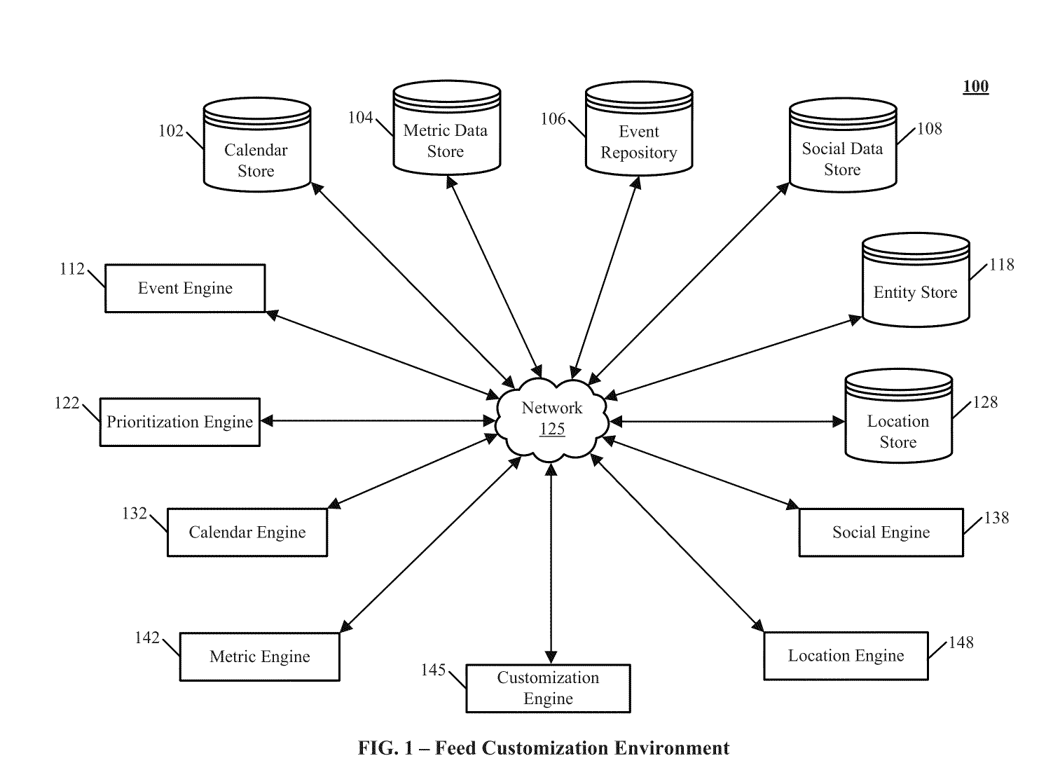

FIG. 1 illustrates one implementation of a feed customization environment 100. FIG. 1 also shows that environment 100 can include calendar store 102, metric data store 104, event repository 106, social data store 108, entity store 118, and location store 128. FIG. 1 also includes event engine 112, prioritization engine 122, calendar engine 132, social engine 138, metric engine 142, customization engine 145, and location engine 148. In other implementations, environment 100 may not have the same elements as those listed above and/or may have other/different elements instead of, or in addition to, those listed above. The different elements can be combined into single software modules and multiple software modules can run on the same hardware.

Regarding the calendar store 102, it can provide a calendar populated with calendar events related to a salesman and include tools for managing the calendar events. In some implementations, calendar store 102 can store at least calendar entries, event subscriptions, sign-ins, and check-ins related to a sales meeting. In other implementations, it can provide specific details related to the sales meeting such as attendees the sales meeting.

In some implementations, calendar engine 132 can monitor a salesman's calendar and identify a calendar event. In other implementations, it can register a schedule event in memory (e.g. calendar store 102) in response to a user selection across a user interface of a user device such as a personal computer, laptop computer, tablet computer, smartphone, etc. The schedule event can represent at least calendar entries, event subscriptions, sign-ins, and check-ins related to a sales meeting and further specify one or more event attributes such as attendees at the sales meeting. In one implementation, calendar engine 132 can automatically register a check-in event in memory. It can automatically obtain check-in information for the salesman via a smartphone or other device which includes a GPS and appropriate communications capability.

In some implementations, location store 128 can hold location information related to a sales meeting. In other implementations, location store 128 can store at least calendar entries, event subscriptions, sign-ins, and check-ins or references to the same related to the sales meeting. In one implementation, it can provide specific details related to the sales meeting such as longitude and latitude of the sales meeting. In one implementation, it can include elevation. In another implementation, a user such as the salesman can populate the location store 128 by specifying sales meeting's location on a calendar application or service running on a user device such as a personal computer, laptop computer, tablet computer, smartphone, etc.

In some implementations, location engine 148 can identify a salesman's location and store it as a location record in the location store 128. The location record can include latitude and longitude co-ordinates of salesman's real-time geographic location. In one implementation, it can include elevation. In some implementations, location engine 148 can obtain location information of the salesman when the salesman arrives at a site that is equipped with WiFi, near field communication (NFC) technology or quick response (QR) codes adapted to interact with a mobile communications device. In both of these examples, a smartphone can be equipped with the requisite communications and/or imaging capabilities to communicate with the on-site equipment and communicate results to a remote server such as the location engine 148.

The arrival of the salesman at the sales meeting can be detected automatically using GPS, WiFi, NFC or QR codes. In some implementations, the location engine 148 can perform location comparisons using GPS information to ascertain that the salesman is within ten feet of a gate or an attendee at the sales meeting. Other threshold distances such as or in a range of 5, 10, 20 or 50 feet can be used. This verification can be used to initiate a check-in process. In other implementations, WiFi fingerprints/triangulation, NFC proximity and QR scanning codes can be used to immediately detect the arrival of the salesman at the sales meeting. Once the arrival is detected, a check-in process can be automatically initiated.

In some implementations, a check-in request can be automatically generated when an arrival is detected. This can be in the form of a check-in request presented to the salesman via his or her smartphone or other mobile computing and communications device. In some other implementations, the check-in request can be fully automatic, providing only a short message on the device. In one implementation, the salesman can be presented with a prompt and a response can be requested. In another implementation, the check-in can proceed silently without notifying the salesman. In any of the above or other implementations, the check-in request can be delayed for a period of time or an indicator can be set to show that a check-in request is pending and that a response is awaited.

In some implementations, a check-in response can be received from the salesman. In other implementations, the check-in response can be immediately initiated after a check-in request is generated. In other implementations, the check-in response can be initiated in response to salesman's actions such as selecting an indicator displayed on a screen of a mobile communications device. In other implementations, the salesman can share his or her check-in information with other members of his sales team. In some implementations, the salesman can access check-in information for other members of his sales team to avoid scheduling a sales meeting with the same customer twice in the same day.

In some implementations, entity store 118 can include real-world entities such as individuals, groups, organizations, etc. mentioned or encoded in feed items for posting on online social environments. In other implementations, these entities can have accounts registered at multiple online social environments. In one implementation, entity store 118 can hold entity mentions with supplemental entity attributes of the real-world entities. Entity attributes can represent properties and/or characteristics of the real-world entities such as names, addresses, job titles, usernames, contact information, employer names, etc. according to some implementations.

In some implementations, entity mentions can be web or database profiles of the real-world entities stored as a system of interlinked hypertext documents that can be accessed via the network 125 (e.g., the Internet). Examples of entity mentions can include social profiles, social handles, unified resource locators (URLs), business-to-business contacts, etc. In other implementations, entity store 118 can hold business-to-business data such as accounts, contacts and leads along with some supplemental information. In other implementations, this supplemental information can be names, addresses, number of employees, and other entity-related information.

Regarding event engine 112, it can crawl the network 125 to find information related to an account or prospect (e.g., a company, firm or organization) present at the sales meeting including latest news articles, revenue, stock rates, etc. The recent new information related to the account or prospect can be stored in event repository 106. This information can help the salesman to stay updated with the recent activities of the account or prospect. In other implementations, event repository 106 can be populated by the event engine 112 to include standard profile information about the account or prospect, which can be extracted from company websites, business registration sources such as Hoovers or D&B, business intelligence sources, and/or social networking websites like Yelp, Yellow Pages, etc.

In some implementations, event repository 106 can include most recently used information that identifies selected meeting-related content that was most recently accessed by the salesman. In other implementations, event engine 112 can identify most recent information accessed by the salesman from one or more devices such as a laptop computer, tablet computer, smartphone, etc. The event engine 112 can also receive user preferences from the salesman to query most recently used information from a particular device pre-assigned by the salesman. In some other implementations, event repository 106 can include content such as documents, images, videos, etc. related to a company at the sales meeting. This can allow the salesman to quickly and efficiently access information associated with the company.

In some implementations, event engine 112 can register a stage event in memory (e.g., event repository 106) that identifies at least one stage of a sales cycle of which the sales meeting is a part. For instance, the sales cycle can include various stages such as referrals, relationship establishment, need analysis, pitch, marketing, negotiation, closing, service or product fulfillment, follow up, etc. In other implementations, event engine 112 can extract necessary documents required at the particular stage of the sales cycle from the event repository 106 and provide them to the salesman during the sales meeting. In one implementation, the stage of the sales cycle can be automatically identified based on time elapsed since the sales cycle had started. In another implementation, the stage of the sales cycle can identified based on user input across a computing device that specifies the stage of the sales cycle.

The event engine 112 can search the network 125 to find information related to a company at a sales meeting by such as the company's website, contact information, web mentions, etc. This information can be stored in the event repository 106 for access by the salesman. In some implementations, event engine 112 can present the salesman with communication records between the salesman and individuals working for the company at the sales meeting. These communication records can be stored in event repository 106 and include e-mails, phone calls, SMSs, chat messages, etc. exchanged between the salesman and individuals working for the company at the sales meeting. In one implementation, event engine 112 can filter these communication records based on a particular sales meeting, deal, event, individual, stage, sales cycle, calendar event, etc. In another implementation, it can also receive user preferences from the salesman to search communication records from a specific user assigned device such as a smartphone or a specific email client like Outlook, Gmail, etc.

In some implementations, a list of attendees can be received from the salesman via a user input across a computing device. In other implementations, the attendees can opt-in to the sales meeting or accept an electronic invitation for the sales meeting across a scheduling application or service running on a computing device. The social engine 138 can then crawl various person-related data sources such as access controlled application-programming interfaces (APIs), public internet and social networking sites to find any common online social connections between the salesman and attendees at the sales meeting. The retrieved social connections can be stored in the social data store 108.

Regarding different types of person-related data sources, APIs like Yahoo Boss, Facebook Open Graph, Twitter Firehose can provide real-time search data aggregated from numerous social media sources such as Yahoo, Facebook and Twitter. These APIs can initialize sorting, processing and normalization of person-related data. Public Internet can provide person-related data from public sources such as first hand websites, blogs, web search aggregators, and social media aggregators. Social networking sites can provide person-related data from social media sources such as Twitter, Facebook, LinkedIn, and Klout.

The social data store 108 can include social media content like social media sources, social accounts, social personas, social profiles, social handles, etc. In some implementations, social media content can add social context to the business-to-business contacts held in the entity store 118. Conversely, business-to-business contacts can add business context to the social personas or profiles according to some other implementations.

Social handles from various person-related data sources can be stored in social data store 108. In some implementations, social handles can identify the usernames selected by the attendees and the accompanying URL like http://twitter.com/username. In other implementations, Facebook profiles of the attendees can be stored in social data store 108, which can include their Facebook pictures, posts, feeds, messages, etc.

The event engine 112 can assemble all the found information as packages for unified access by the salesman according to some implementations. In other implementations, it can assemble the found information based on user preferences such as client type, location of the sales meeting, priority criteria, context of the sales meeting, product type, product lifecycle, contractual requirements, stages of the sales cycle, sales cycle, etc.

Some implementations can also have the event engine 112 allocating the information packages to on-demand systems accessible by one or more user assigned devices. For instance, location information related to the sales meeting can be allocated to a multi-tenant database (MTDB) accessible by salesman's smartphone device. In other implementations, selected meeting-related content such as product presentations can be made accessible through a tablet computer used by the salesman.

In some implementations, event engine 112 can identify other members of salesman's sales team that are to be contacted at the end of the sales meetings and then further establish correspondence with them. For example, the event engine 112 can forward legal documents related to the sales meeting to members of the legal department of salesman's organization. In another example, it can forward marketing material related to the sales meeting to members of the marketing team of salesman's organization.

In some implementations, event engine 112 can identify information related to other members of the salesman's sales team that are at least associated with the company or attendees at the sales meeting. In other implementations, it can identify those members of the salesman's sales team that at least: have successfully worked with a selected prospect in accordance with work history of other members of the salesman's sales team, have previously worked with the selected prospect in accordance with check-in history of other members of the salesman's sales team, are available to coordinate the sales meeting in accordance with electronic calendars of other members of the salesman's sales team, and have skills required for coordinating the sales meeting in accordance with work profiles of other members of the salesman's sales team.

In some implementations, social data store 108 can include a user profile that includes data about the user of the database system. The data can include general information, such as title, phone number, a photo, a biographical summary, and a status (e.g., text describing what the user is currently doing). In other implementations, the data can include messages created by other users. Where there are multiple tenants, a user can be associated with a particular tenant. For instance, a user can be a salesman of a company that is a tenant of the database system that provides a database service.

In some implementations, social data store 108 can include a feed that is a combination (e.g. a list) of feed items. A feed item or feed element can include information about a user of the database referred to as profile feed or about a record referred to as record feed. A user following the user or record can receive the associated feed items. The feed items from all of the followed users and records can be combined into a single feed for the user.

In some implementations, an information feed in the context of a social network can be a collection of information selected from the social network for presentation in a user interface. The information presented in the information feed can include entries posted to a user's wall or any other type of information accessible within the social network. For example, a user's news feed can include text inputs such as comments (e.g., statements, questions, emotional expressions), responses to comments (e.g., answers, reactionary emotional expressions), indications of personal preferences, status updates, and hyperlinks. As another example, a news feed can include file uploads, such as presentations, documents, multimedia files, and the like.

In some implementations, a feed item can be a message, post, update stream, and/or a story (also called a feed tracked change). A feed can be a combination of messages and stories. Messages can include text created by a user, and other data as well. Examples of messages include posts, status updates, likes, replies, shares, and comments. Messages can be created for a user's profile or for a record. Posts can be created by various users, potentially any user, although some restrictions can be applied. As an example, posts can be made to a wall section of a user's profile (which can include a number of recent posts) or a section of a record that includes multiple posts. The posts can be organized in chronological order. In contrast to a post, a status update changes a status of a user and is made by that user. Other similar sections of a user's profile can also include an “About” section. A record can also have a status, whose update can be restricted to the owner of the record. The owner can be a single user, multiple users, or a group. In other implementations, there is only one status for a record.

In some implementations, a comment can be made on any feed item. In another implementation, comments can be organized as a list explicitly tied to a particular story, post, or status update. In this implementation, comments may not be listed in the first layer (in a hierarchal sense) of feed items, but listed as a second layer branching from a particular first layer feed item.

In some implementations, social data store 108 can include a story, which is data representing an event, and can include text generated by the database system in response to the event. In one implementation, the data can initially be stored, and then the database system can later use the data to create text for describing the event. Both the data and/or the text can be a story.

In some implementations, social data store 108 can include a group, which is a collection of users. In other implementations, the group can be defined as users with a same or similar attribute, or by membership. In one implementation, a group feed can include any feed item about any user in a group. In another implementation, a group feed can include feed items that are about the group as a whole. In one implementation, the feed items for a group are only posts and comments.

In some implementations, social data store 108 can include an entity feed or record feed that refers to a feed of feed items about a particular record in the database, such as stories about changes to the record and posts made by users about the record. An entity feed can be composed of any type of feed item. Such a feed can be displayed on a page (e.g. a web page) associated with the record (e.g. a home page of the record). In other implementations, a profile feed is a feed of feed items about a particular user. In one implementation, the feed items for a profile feed can be posts and comments that other users make about or send to the particular user, and status updates made by the user. Such a profile feed can be displayed on a page associated with the particular user. In another implementation, feed items in a profile feed can include posts made by the particular user and feed tracked changes (stories) initiated based on actions of the particular user.

In one implementation, a user can make a comment within a user's news feed. Such a comment can propagate to the appropriate profile feed or record feed, and then to the news feeds of the following users. Thus, feeds can include what people are saying, as well as what they are doing. In one aspect, feeds are a way to stay up-to-date (e.g., on users, opportunities, etc.) as well as an opportunity to reach out to co-workers/partners and engage them around common goals.

In some implementations, a feed item can include one or more actionable selections configured to interact with the record. The one or more actionable selections can be actionable buttons providing a reference to the publisher. Selecting one of the actionable selections can cause the publisher to be operable to receive information associated with the record for record updates. For instance, if the record is a case, one of the actionable selections can enable the user to send an email to resolve the case via the publisher.

In some implementations, prioritization engine 122 can prioritize feed items in a feed based on or more metrics as described later in this application. In some other implementations, metric engine 142 can calculate various metrics such as an interaction metric, location proximity metric, engagement metric based on one or more entity attributes or actions. These metrics can be stored in metric data store 104.

In some implementations, customization engine 145 can generate customized views of a user profile by reorganizing a feed to include feed items prioritized by the prioritization engine 122. In other implementations, the customized view can be automatically generated when a trigger occurs such as when a window of time hits or a reference location is registered. For instance, when an event is registered, the customization engine 145 can use triggers to initiate the corresponding data deployment drill to create and present a customized view. Triggers can act as scripts that execute before or after specific data manipulation language (DML) events occur, such as before object records are inserted into the database, timestamps values are recorded or after records have been deleted.

In some other implementations, the customization engine 145 can create customized views based on work flow rules. For instance, workflow rules can automate creation and presentation of customized views based on user assignment and preferences such as transferring files with certain file types for display in a particular customized view. In yet other implementations, approval processes can be used to receive approval from the salesman regarding any customized view.

### Event-Based Schema

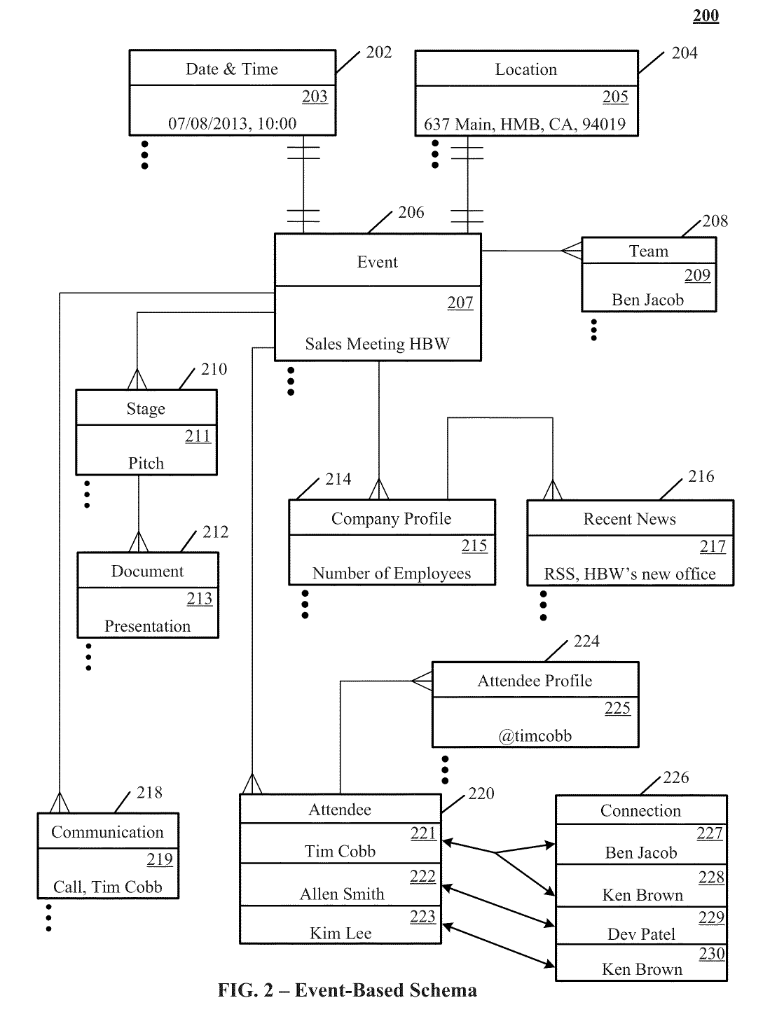

FIG. 2 illustrates one implementation of an event-based schema 200. FIG. 2 shows that schema 200 for one or more logical objects. For convenience, groups of attributes are referred to in the following description as residing within a table. In some implementations, what this description refers to as tables can be combined into a single table or single data object. The attributes identified as being stored within a table can be part of a larger object in some database implementations. Other descriptions of multi-tenant database structures used by Salesforce.com explain how multiple type of objects with different fields can be stored in a single table or a horizontally partitioned table. Schema 200 can include an event table 206. In some implementations, event table 206 can be associated with a date and time table 202 and location table 204 via one-to-one mappings. It can also be mapped to a team table 208 and stage table 210 through one-to-many mapping. The stage table 210 can be further linked to a document table 212. The event table 206 can also be associated with a company profile table 214 via one-to-many mapping, which can be further linked to recent news table 216 through a one-to-many relationship. The event table 206 can also be mapped to communication table 218 and attendee table 220 via one-to-many relationships. The attendee table 220 can be further linked to an attendee profile table 224 and connection table 226 through one-to-many mappings.

In other implementations, schema 200 may not have the same tables, entries or fields as those listed above and/or may have other/different tables or fields instead of, or in addition to, those listed above. In some implementations, event table 206 can be associated with tables for other online social environments like Chatter, Klout, etc. In other implementations, the event table 206 can be mapped to a supplemental information table that can include fields such as pseudonyms, addresses, phone numbers, employer names, etc.

When a salesman schedules an event such as a sales meeting, that event can be stored in the event table 206. For example, the event table 206 can include event entry 207 such as “Sales Meeting HBW.” In some implementations, event entry 207 can be specified via a user input by the salesman across a calendar application or service running on a user device. In other implementations, event table 206 can have one or more of the following variables with certain attributes: EVENT_ID being CHAR (15 BYTE), EVENT_HISTORY_ID being CHAR (15 BYTE), PARENT_ID being CHAR (15 BYTE), CREATED_BY being CHAR (15 BYTE), CREATED_DATE being a variable of type DATE, DIVISION being a NUMBER, KEY_PREFIX being CHAR (3 BYTE), and DELETED being CHAR (1 BYTE). The parent ID can provide an ID of a parent object in case the change is promulgated to the parent. The key prefix can provide a key that is unique to a group of records, e.g., custom records (objects). The deleted variable can indicate that the feed items for the event are deleted, and thus the feed items are not generated.

Some implementations can include the salesman further specific content related to a selected meeting across the calendar application or service. In some implementations, event table 206 can be associated to a date and time table 202 via a one-to-one relationship that identifies the date and time entry 203 of event entry 207 such as “07/08/2013, 10:00.” In other implementations, date and time table 202 can have one or more of the following variables with certain attributes: EVENT_ID being CHAR (15 BYTE), PARENT_EVENT ID being CHAR (15 BYTE), CREATED_BY being CHAR (15 BYTE), CREATED_DATE being a variable of type DATE, DIVISION being a NUMBER, and KEY_PREFIX being CHAR (3 BYTE).

In some implementations, location of an event can be stored in a location table 204. It can specify location entry 205 of event 207 using street address like “637 Main, HMB, Calif., 94019.” In other implementations, location table 204 can include a location aware entry 205 with location as a common key, and be further associated with various classes such as accounts, prospects, events and people. In another implementation, these relations can be changed or augmented by adding additional classes. For instance, location aware entry 205 can be directly associated with a check-ins table. In yet other implementations, location entry 205 can be augmented by storing geographic location as longitude and latitude coordinates. In other implementations, location table 204 can have one or more of the following variables with certain attributes: LOCATION ID being CHAR (15 BYTE), PARENT_EVENT ID being CHAR (15 BYTE), CREATED_BY being CHAR (15 BYTE), CREATED_DATE being a variable of type DATE, DIVISION being a NUMBER, and KEY_PREFIX being CHAR (3 BYTE).

In some implementations, stage of an event within a sales cycle can be specified in a stage table 210. For instance, the stage of event entry 207 can be identified as “pitch” using a stage entry 211. In other implementations, stage entry 211 can include various stages of the sales cycle such as referrals, relationship establishment, need analysis, marketing, negotiation, closing, service or product fulfillment, follow up. In yet other implementations, stage table 210 can have one or more of the following variables with certain attributes: STAGE_ID being CHAR (15 BYTE), SALES_CYCLE_ID being CHAR (15 BYTE), PARENT_EVENT ID being CHAR (15 BYTE), CREATED_BY being CHAR (15 BYTE), CREATED_DATE being a variable of type DATE, DIVISION being a NUMBER, and KEY_PREFIX being CHAR (3 BYTE).

Some other implementations can include the stage table 210 being mapped to a document table 212 that specifies one or more documents 213 (e.g., “presentation”) required at a particular stage of a sales cycle. These specifications can be configured based on the sales man's organization's workflows, rules and policies, etc. In yet other implementations, document table 212 can have one or more of the following variables with certain attributes: DOCUMENT_ID being CHAR (15 BYTE), STAGE_ID being CHAR (15 BYTE), SALES_CYCLE_ID being CHAR (15 BYTE), PARENT_EVENT ID being CHAR (15 BYTE), CREATED_BY being CHAR (15 BYTE), CREATED_DATE being a variable of type DATE, DIVISION being a NUMBER, and KEY_PREFIX being CHAR (3 BYTE).

Information related to an account or prospect at the sales meeting can be identified in a company profile table 214 according to some implementations. The company profile table 214 can include various fields 215 such as number of employees, industry, market share, stock rate, etc. In yet other implementations, company profile table 214 can have one or more of the following variables with certain attributes: COMPANY_ID being CHAR (15 BYTE), SOURCE_ID being CHAR (15 BYTE), PARENT_EVENT ID being CHAR (15 BYTE), CREATED_BY being CHAR (15 BYTE), CREATED_DATE being a variable of type DATE, DIVISION being a NUMBER, and KEY_PREFIX being CHAR (3 BYTE).

In one implementation, the company profile table 214 can be linked to a recent news table 216 through one-to-many relationships. The recent news table 216 can include recent news about the company at the sales meeting that can be accumulated from various sources such as the Internet. The fields 217 of the recent news table 216 can include news articles, blogs, alerts, updates, RSS feeds such as “HBW's new office . . . ” etc. In other implementations, the recent news table 216 can also include fields that specify the types of sources from which news is assembled. In yet other implementations, recent news table 216 can have one or more of the following variables with certain attributes: CONTENT_ID being CHAR (15 BYTE), SOURCE_ID being CHAR (15 BYTE), PARENT_COMPANY_ID being CHAR (15 BYTE), CREATED_BY being CHAR (15 BYTE), CREATED_DATE being a variable of type DATE, DIVISION being a NUMBER, and KEY_PREFIX being CHAR (3 BYTE).

In some implementations, communication table 218 can store any communication exchanges between the salesman and a current or prospective customer such as emails, SMS, telephonic conversations, video conferences, etc. as various fields 219. These fields 219 can be populated using names of contacted clients or customers along with the means of communication used to contact the clients or customers, such as “Call, Tim Cobb.” In other implementations, it can specify the duration of the means of communication along with a timestamp that specifies time and date of the communication. In yet other implementations, communication table 218 can have one or more of the following variables with certain attributes: COMMUNICATION_ID being CHAR (15 BYTE), INITIATOR_ID being CHAR (15 BYTE), RECEPIENT_ID being CHAR (15 BYTE), PARENT_EVENT_ID being CHAR (15 BYTE), CREATED_BY being CHAR (15 BYTE), CREATED_DATE being a variable of type DATE, DIVISION being a NUMBER, and KEY_PREFIX being CHAR (3 BYTE).

Some implementations can include holding information related to attendees at the sales meeting in the attendee table 220. It can include a list of various attendees at the sales meeting such as “Tim Cobb” 221, “Allen Smith” 222 and “Kim Lee” 223. This table can be further mapped to an attended profile table 224 that includes social profiles of the attendees specified in the attendee table 220 such as Twitter handle “@timcobb” 225 of attendee “Tim Cobb” 221.

Some other implementations can include connecting the attendees of the sales meeting with other members of the salesman' sales team with whom the attendees are socially connected on online social networks such as Facebook, Twitter, LinkedIn, etc. These connections can be made by mapping the attendee fields 221, 222 and 223 of the attendee table 220 with the corresponding fields 227, 228, 229, and 230 of the connection table 226. In some implementations, a single attendee can be connected to multiple members and vice-versa. In yet other implementations, attendee table 220 can have one or more of the following variables with certain attributes: ATTENDEE_ID being CHAR (15 BYTE), CONNECTION_ID being CHAR (15 BYTE), PROFILE_ID being CHAR (15 BYTE), PARENT_EVENT ID being CHAR (15 BYTE), CREATED_BY being CHAR (15 BYTE), CREATED_DATE being a variable of type DATE, DIVISION being a NUMBER, and KEY_PREFIX being CHAR (3 BYTE).

### Event-Based Customized View

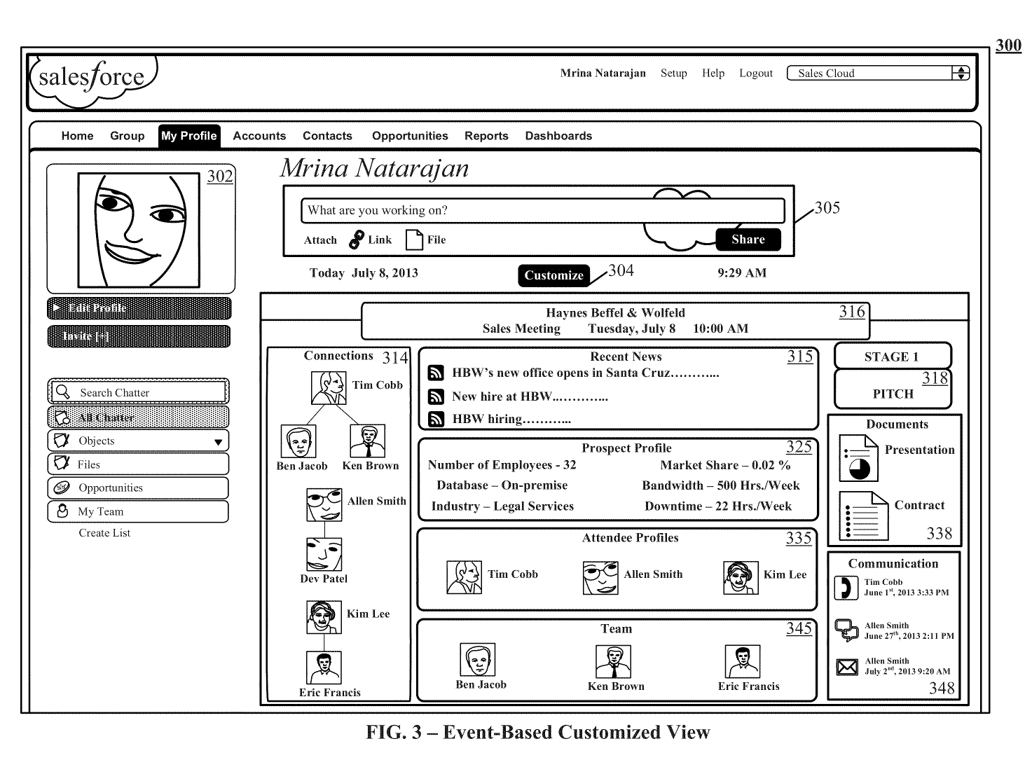

FIG. 3 illustrates one implementation of an event-based customized view 300 for providing sales related content to a salesman for a sales meeting. In particular, FIG. 3 illustrates an example social profile of user 302 “Mrina Natarajan” on an online social network such as Salesforce's Chatter. In some implementations, customized view 300 can be presented on different online social environments such as Klout, Facebook, Twitter, LinkedIn, etc. FIG. 3 also shows a feed tab 305, connections tab 314, recent news tab 315, event tab 316, stage tab 318, prospect profile tab 325, attendee profiles tab 335, team tab 345, documents tab 338, and communication tab 348. In other implementations, customized view 300 may not have the same screen objects or tabs as those listed above and/or may have other/different screen objects or tabs instead of, or in addition to, those listed above such as a social handle tabs, privacy tabs, groups tab, tag formats tabs, members tab, and the like.

In some implementations, customized view 300 can provide an interface or dashboard for prioritizing content feeds based on an event. In other implementations, customized view 300 can take one of a number of forms, including a dashboard interface, engagement console, and other interface, such as a mobile interface or summary interface.

In some implementations, customized view 300 can be hosted on a web-based or cloud-based application running on any computing device such as a personal computer, laptop computer, mobile device or any other hand-held computing device. It can also be hosted on a non-social local application running in an on-premise environment. In other implementations, customized view 300 can be accessed from a browser running on a computing device. The browser can be Chrome, Internet Explorer, Firefox, Safari, etc.

In some implementations, customized view 300 as an engagement console can run on a computer desktop application primarily used for multi-user content engagement. The engagement console can present screen tabs 302, 305, 314, 315, 318, 325, 335, 345, 338, and 348 into configurable “stacks” such that users can create new feed items for multiple posts. These stacks can also support various filters and execution of workflow macros allowing users to assign rules and triggers to the feed prioritization. For instance, users can specify a trigger that automatically prioritizes a feed item based on pre-assigned workflow macros such as entity mentions, online social environments and other entities with whom feeds can be shared.

Some implementations can include user 302 typing new and/or update existing messages, posts, replies, feeds, comments, etc. that include entity mentions using the feed tab 305. In some implementations, feed tab 305 can provide a status indication or change of status of user 302. In some implementations, connections tab 314 can display the connection network between attendees of the sales meeting and other members of the salesman's sales team. As shown in connections tab 314, attendee “Tim Cobb” is connection to sales team members “Ben Jacob” and “Ken Brown.” In other implementations, selecting a customize screen button 304 can prioritize the feeds based on the preferences of user 302.

The recent news tab 315 can display recent news associated with a company at the sales meeting according to some implementations. The news can be assembled from various news websites, blogs, articles, RSS feeds, etc. In one implementation, event tab 316 can provide information related to the event, including title of the event, name of the company at the event, time and date of the event, etc.

Some implementations can include the stage tab 318 specifying the stage of the event within a sales cycle. As show in stage tab 318, the stage of the sales meeting can be “pitch.” In other implementations, the documents required at the stage specified in stage tab 318 can be display in the documents tab 338. As shown in documents tab 338, documents required at stage “pitch” can include a “presentation” and a “contract”.

In some implementations, prospect profile tab 325 can provide a business-to-business profile of the company that highlights various attributes of the company that can help the salesman have a better understanding of the company. Examples of attributes can include database platform, market share, industry type, stock rate, downtime, bandwidth, etc. In some other implementations, profiles of the attendees can be displayed using the attendee profiles tab 335. These profiles can be social profile of the attendees on various online social networks and company websites or business-to-business stored in a master database or repository such as Jigsaw. In yet other implementations, communication history between the salesman and the attendees can be display via the communication tab 348, which can provide a graphical representation of the means of communication such as a phone call, chat, e-mail along with other supplemental information associated with the communication such as duration, timestamps, etc.

In one implementation, regarding team tab 345, it can display those members of the salesman's sales team that are at least associated with the company or attendees at the sales meeting. In other implementations, team tab 345 can show those members of salesman's sales team that to be contacted at the end of the sales meetings. This implementation can be based on the salesman's organization's work flow rules and stage of the event. In other implementations, the corresponding members can be automatically contacted or notified at the end of the sales meeting by feed posting their social profiles, e-mails, message, etc.

### Target Entity-Based Records

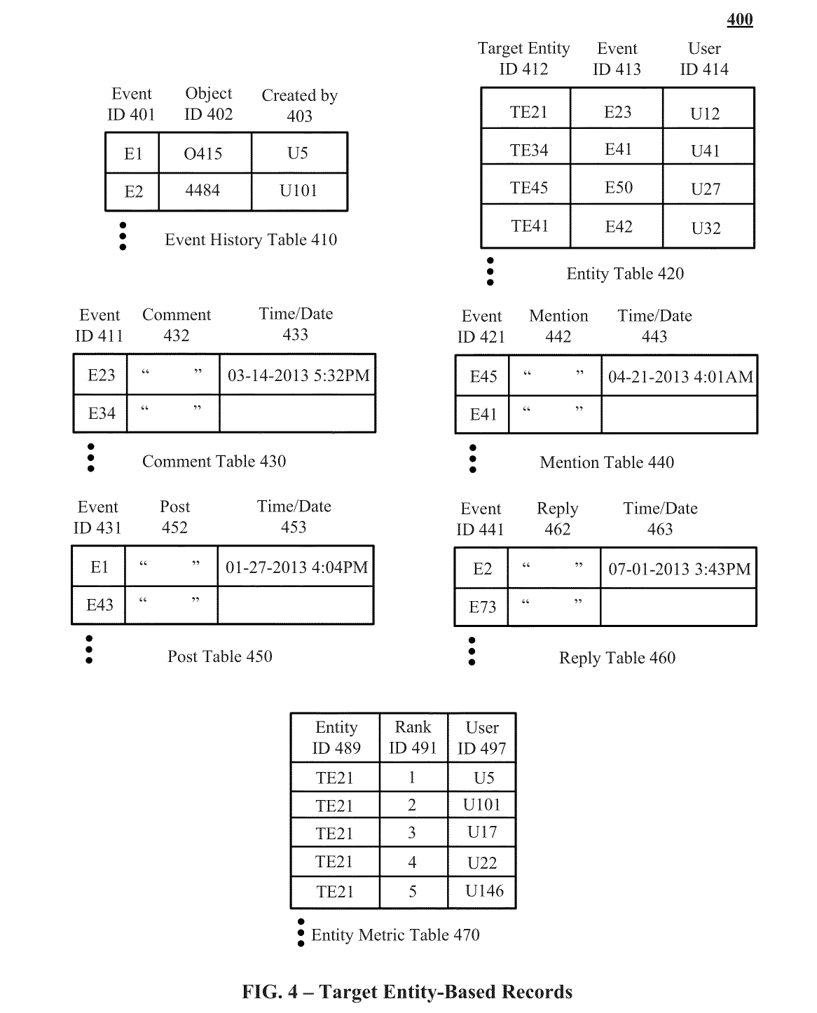

FIG. 4 shows one implementation 400 of a plurality of tables that can be used for target entity-based prioritization. As described above, this and other data structure descriptions that are expressed in terms of tables also can be implemented as objects or in tables that store multiple record or object types. Reference to tables is for convenience of explanation and not as a limitation on the data structure implementation. FIG. 4 can include an event history table 410, entity table 420, comment table 430, mention table 440, post table 450, reply table 460, and entity metric 470. In other implementations, implementation 400 may not have the same tables, entries or fields as those listed above and/or may have other/different tables, entries or fields instead of, or in addition to, those listed above.

In some implementations, event history table 410 can provide a history of events from which feed items are posted or created. In other implementations, the events can be for objects that are being tracked. Thus, table 410 can store and change history for feeds, and the changes can be persisted. In various implementations, event history table 410 can have columns of event ID 401, object ID 402 (also called parent ID), and created by 403. The event ID 401 can uniquely identify a particular event and can start at 1 (or other number or value).

In some implementations, each new event can be added chronologically with a new event ID, which can be incremented in order. An object ID 402 can be used to track which record or user's profile is being changed. For example, the object ID can correspond to the record whose field is being changed or the user whose feed is receiving a post or the user who is posting the feed. The created by ID 403 can track the user who is performing the action that results in the event, e.g., the user that is changing the field or that is posting a message to the profile of another user, in this example the user being U5.

In some other implementations, event history table 410 can have one or more of the following variables with certain attributes: ORGANIZATION_ID being CHAR (15 BYTE), FEEDS_HISTORY_ID being CHAR (15 BYTE), PARENT ID being CHAR (15 BYTE), CREATED_BY being CHAR (15 BYTE), CREATED_DATE being a variable of type DATE, DIVISION being a NUMBER, KEY_PREFIX being CHAR (3 BYTE), and DELETED being CHAR (1 BYTE). The parent ID can provide an ID of a parent object in case the change is promulgated to the parent. The key prefix can provide a key that is unique to a group of records, e.g., custom records (objects). The deleted variable can indicate that the feed items for the event are deleted, and thus the feed items are not generated.

In some implementations, entity table 420 can provide a list of target entities and events surrounding the target entities. In various implementations, event table 420 can have columns of target entity ID 412, event ID 413 and user ID 414. In other implementations, a user that performs the event E23 can be specified through username U12. As shown, the user U12 performed the event E23 surrounding the target entity TE21. In other implementations, entity table 420 can include a counter that counts the number of events performed by a particular user around a particular target entity. Examples of different types of events can include posting feed items or messages, making comments, mentions or replies, sharing pictures, etc. related to the target entity. Another example can include following the target entity's record, group, profile, or web page.

In some other implementations, a point system can be used to represent the magnitude a user's activities or events surrounding a target entity such that each of the different types of events can be assigned different points. Based on the number of points obtained by the user, a cumulative score can be generated periodically. This cumulative score can be used in an entity metric to make comparative engagement-based analysis between multiple users, as described later in this application.

In some implementations, a comment table 430 can provide a feed of the comments made regarding an event, e.g., a comment on a post. The columns of table 430 can include an event ID 411 (which correlates to the event ID 401), the comment column 432 that stores the text of the comment, and the time/date 433 of the comment. In one implementation, there can be multiple comments for each event. As shown, event ID 411 has two entries, E23 and E34. In some other implementations, comment table 430 can have one or more of the following variables with certain attributes: ORGANIZATION_ID being CHAR (15 BYTE), FEEDS_COMMENTS_ID being CHAR (15 BYTE) and uniquely identifying each comment, PARENT_ID being CHAR (15 BYTE), CREATED_BY being CHAR (15 BYTE), CREATED_DATE being DATE, COMMENTS being VARCHAR2 (420 BYTE), and DELETED being CHAR (1 BYTE).

In one implementation, entity mentions embedded and encoded in feed items can be stored in a child table (mention table 440), which can be cross-referenced with event history table 410. Mention table 440 can include event ID 421 (to cross-reference with event ID 401), mention text 442 to store the text of the mention, and time/date 443. An entry in mention table 440 can be considered a feed post object.

In one implementation, the text of posts can be stored in a child table (post table 450), which can be cross-referenced with event history table 410. Post table 450 can include event ID 431 (to cross-reference with event ID 401), post text 452 to store the text of the post, and time/date 453. An entry in post table 450 can be considered a feed post object.

In one implementation, the text of replies can be stored in a child table (reply table 460), which can be cross-referenced with event history table 410. Reply table 460 can include event ID 441 (to cross-reference with event ID 401), reply text 462 to store the text of the reply, and time/date 463. An entry in reply table 460 can be considered a feed post object.

In some implementations, the most engaged user around a target entity can be identified using the entity metric table 470. In other implementations, entity metric table 470 can provide the engagement strength of a particular user with a particular target entity. It can arrange or rank them in an ascending or descending order. For example, entity metric table 470 can provide a ranking with rank ID 491 of most-engaged users with user ID 497 corresponding to target entity TE21 with entity ID 489 in a descending order such that U5, U101, U17, U22, and U146.

### Target Entity-Based Feed Prioritization

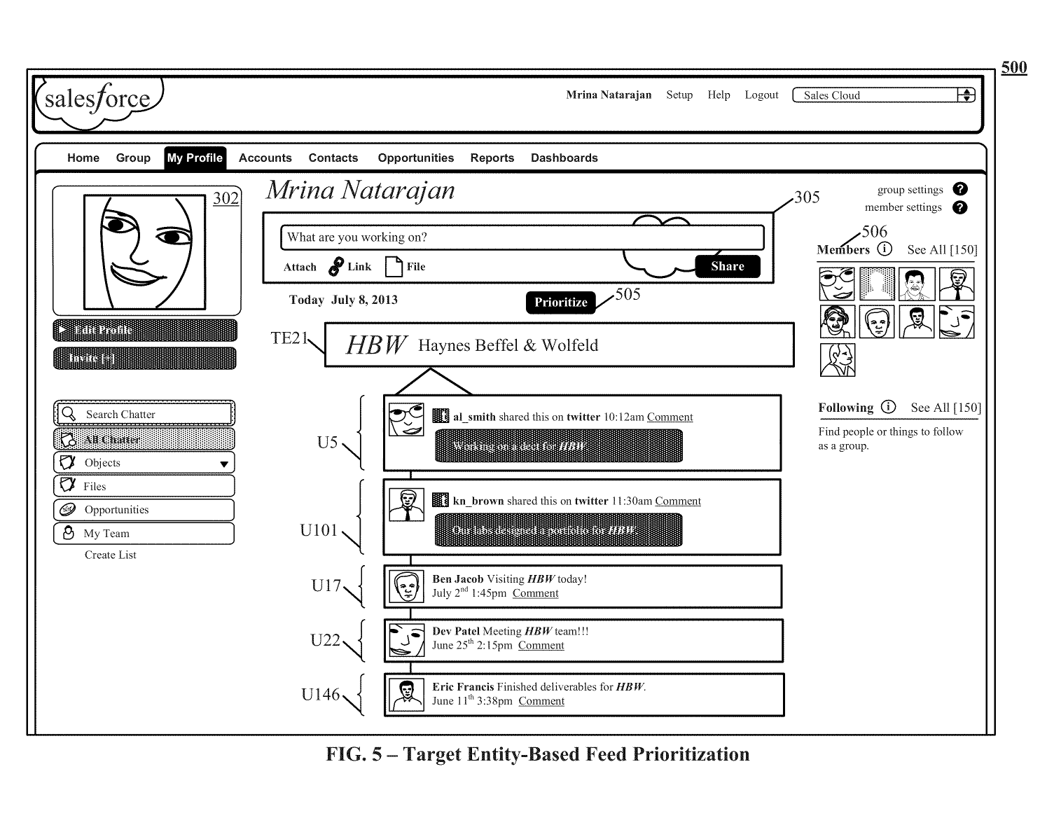

FIG. 5 illustrates one implementation of a target entity-based customized view 500 for prioritizing content feeds based on a target entity. In particular, FIG. 5 presents a customized view 500 that includes a series of feeds prioritized based on the entity metric table 470 described in the previous section “Target Entity-Based Records.” In some implementations, FIG. 5 illustrates an example social profile of user 302 “Mrina Natarajan” on an online social network such as Salesforce's Chatter. FIG. 5 also shows a target entity feed TE21 and feed posting entities U5, U101, U17, U22, and U146. In other implementations, customized view 500 may not have the same screen objects or tabs as those listed above and/or may have other/different screen objects or tabs instead of, or in addition to, those listed above such as a social handle tabs, privacy tabs, groups tab, tag formats tabs, members tab, and the like.

In some implementations, user 302 can choose to prioritize a display of feed from other users or members 506 based on a target entity so that higher rate feed items show up higher on a display. For example, in an implementation where comments are answers to a specific question related to the target entity TE21, user 302 can rate the different status posts so that a best answer can be identified. As another example, user 302 can quickly identify feed items that are most important as those feed items can be displayed at a top of the feed. The order of the feed items can be based on an importance level (which can be determined by the database system using various factors, some of which are mentioned herein) and based on a rating from user 302. In one implementation, the rating is on a scale that includes at least 3 values. In another implementation, the rating can be based on a binary scale.

According to some implementations, the display of feed can be prioritized based on users who are most engaged with a target entity as specified in the entity metric table 470. In other implementations, selecting a prioritize screen button 505 can prioritize the feeds based on the preferences of user 302. In some other implementations, user 302 can assign different importance or points to different actions performed by other users or members 506 to engage with the target entity TE21. For instance, user 302 can choose to see higher on a display those feed items that include attached content such as documents mentioning the target entity TE21. In another example, feed items from those users that mention the target entity TE21 most often or post most messages on the target entity's profile can be identified and ranked higher on a feed display metric.

As an example of target entity-based feed prioritization, “HBW” is selected as the target entity around which the user 302 wants to prioritize his feed. In some implementations, the user 302 can be presented with a filter that can allow user 302 to specify her feed prioritization criteria. In other implementations, user 302 can choose to prioritize her feed based on the level of engagement of other users or members 506 in her online social network with the target entity “HBW” with ID TE21. Upon clicking the prioritize button 505, user 302 can be shown a list of other users that have engaged most with the target entity TE21 within a period of time. In some implementations, this period of time can be specified by the user 302. As shown, feed items from other users U5, U101, U17, U22, and U146 that mention or refer to the target entity “HBW” in various ways can be filtered out and displayed at the top of the view 500.

### Feed Posting Entities-Based Records

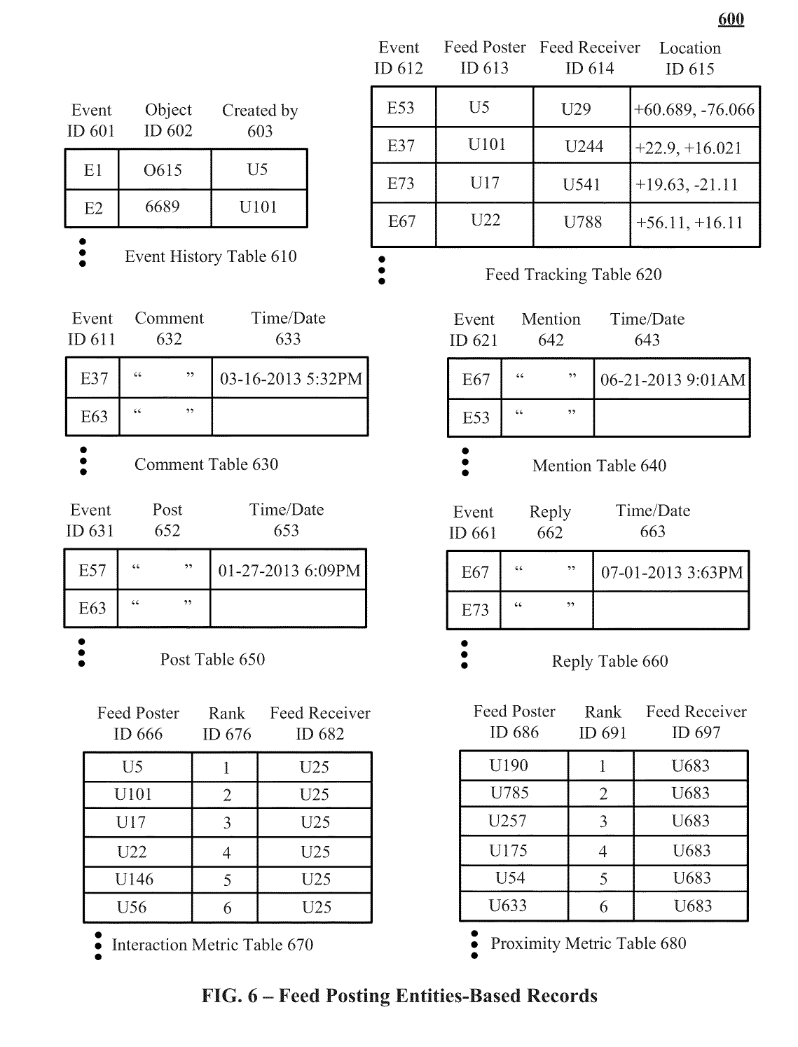

FIG. 6 shows one implementation 600 of a plurality of tables that can be used for feed posting entities-based prioritization. As described above, this and other data structure descriptions that are expressed in terms of tables also can be implemented as objects or in tables that store multiple record or object types. Reference to tables is for convenience of explanation and not as a limitation on the data structure implementation. FIG. 6 can include an event history table 610, feed tracking table 620, comment table 630, mention table 640, post table 650, reply table 660, interaction metric table 670, and proximity metric table 680. In other implementations, implementation 600 may not have the same tables, entries or fields as those listed above and/or may have other/different tables, entries or fields instead of, or in addition to, those listed above.

In some implementations, event history table 610 can provide a history of events from which feed items are posted or created. In other implementations, the events can be for objects that are being tracked. Thus, table 610 can store and change history for feeds, and the changes can be persisted. In various implementations, event history table 610 can have columns of event ID 601, object ID 602 (also called parent ID), and created by 603. The event ID 601 can uniquely identify a particular event and can start at 1 (or other number or value).

In some implementations, each new event can be added chronologically with a new event ID, which can be incremented in order. An object ID 602 can be used to track which record or user's profile is being changed. For example, the object ID can correspond to the record whose field is being changed or the user whose feed is receiving a post or the user who is posting the feed. The created by ID 603 can track the user who is performing the action that results in the event, e.g., the user that is changing the field or that is posting a message to the profile of another user, in this example the user being U5.

In some other implementations, event history table 610 can have one or more of the following variables with certain attributes: ORGANIZATION_ID being CHAR (15 BYTE), FEEDS_HISTORY_ID being CHAR (15 BYTE), PARENT ID being CHAR (15 BYTE), CREATED_BY being CHAR (15 BYTE), CREATED_DATE being a variable of type DATE, DIVISION being a NUMBER, KEY_PREFIX being CHAR (3 BYTE), and DELETED being CHAR (1 BYTE). The parent ID can provide an ID of a parent object in case the change is promulgated to the parent. The key prefix can provide a key that is unique to a group of records, e.g., custom records (objects). The deleted variable can indicate that the feed items for the event are deleted, and thus the feed items are not generated.

In some implementations, feed tracking table 620 can identify for various events (event ID 612) different feed posting entities (feed poster ID 613) and corresponding feed receiving entities (feed receiver ID 614). In various implementations, feed tracking table 620 can have a column for location ID 615 that provides location information about the feed posting entities using longitude and latitude coordinates. As shown, user U5 is a feed posting entity who posted a feed on feed receiving entity U29's profile by performing the event E53. In other implementations, feed tracking table 620 can include a counter that counts the number of events performed by a feed posting entity on a feed receiving entity's profile. Examples of different types of events can include posting feed items or messages, making comments, mentions or replies, sharing pictures, etc. related to the target entity. Another example can include following the target entity's record, group, profile, or web page. In yet other implementations, based on the values of longitude and latitude coordinates, feed posting entities that are most proximate to the feed receiving posting can be identified.

In some implementations, a point system can be used to represent the magnitude of the number of events performed by a feed posting entity on a feed receiving entity's profile such that each of the different types of events can be assigned different points. In some other implementations, points can be assigned to the feed posting entities based on their geographical proximity to the feed receiving entity. Based on the number of points obtained by a feed posting entity, cumulative scores can be generated periodically. These cumulative scores can be used in various metrics to make comparative interaction and proximity based analysis between multiple feed posting entities, as described later in this application.

In some implementations, a comment table 630 can provide a feed of the comments made regarding an event, e.g., a comment on a post. The columns of table 630 can include an event ID 611 (which correlates to the event ID 601), the comment column 632 that stores the text of the comment, and the time/date 633 of the comment. In one implementation, there can be multiple comments for each event. As shown, event ID 611 has two entries, E37 and E63. In some other implementations, comment table 630 can have one or more of the following variables with certain attributes: ORGANIZATION_ID being CHAR (15 BYTE), FEEDS_COMMENTS_ID being CHAR (15 BYTE) and uniquely identifying each comment, PARENT_ID being CHAR (15 BYTE), CREATED_BY being CHAR (15 BYTE), CREATED_DATE being DATE, COMMENTS being VARCHAR2 (420 BYTE), and DELETED being CHAR (1 BYTE).

In one implementation, entity mentions embedded and encoded in feed items can be stored in a child table (mention table 640), which can be cross-referenced with event history table 610. Mention table 640 can include event ID 621 (to cross-reference with event ID 601), mention text 642 to store the text of the mention, and time/date 643. An entry in mention table 640 can be considered a feed post object.

In one implementation, the text of posts can be stored in a child table (post table 650), which can be cross-referenced with event history table 610. Post table 650 can include event ID 631 (to cross-reference with event ID 601), post text 652 to store the text of the post, and time/date 653. An entry in post table 650 can be considered a feed post object.

In one implementation, the text of replies can be stored in a child table (reply table 460), which can be cross-referenced with event history table 610. Reply table 660 can include event ID 661 (to cross-reference with event ID 601), reply text 662 to store the text of the reply, and time/date 663. An entry in reply table 660 can be considered a feed post object.

In some implementations, those feed posting entities that are most interactive with a feed receiving entity can be identified using the interaction metric table 670. In other implementations, interaction metric table 670 can provide the interaction strength of various feed posting entities with a particular feed receiving entity. It can arrange or rank them in an ascending or descending order. For example, interaction metric table 670 can provide a ranking with rank ID 676 of most-interactive feed posting entities with feed ID 666 corresponding to feed receiving entity U25 with feed receiver ID 682 in a descending order such that U5, U101, U17, U22, U149, and U56.

In some implementations, those feed posting entities that are most proximate to a feed receiving entity can be identified using the proximity metric table 680. In other implementations, proximity metric table 680 can provide the location proximity strength of various feed posting entities with a particular feed receiving entity. It can arrange or rank them in an ascending or descending order. For example, proximity metric table 680 can provide a ranking with rank ID 691 of most-proximate feed posting entities with feed ID 686 corresponding to feed receiving entity U683 with feed receiver ID 697 in a descending order such that U190, U785, U257, U175, U54, and U633.

### Feed Posting Entities-Based Feed Prioritization

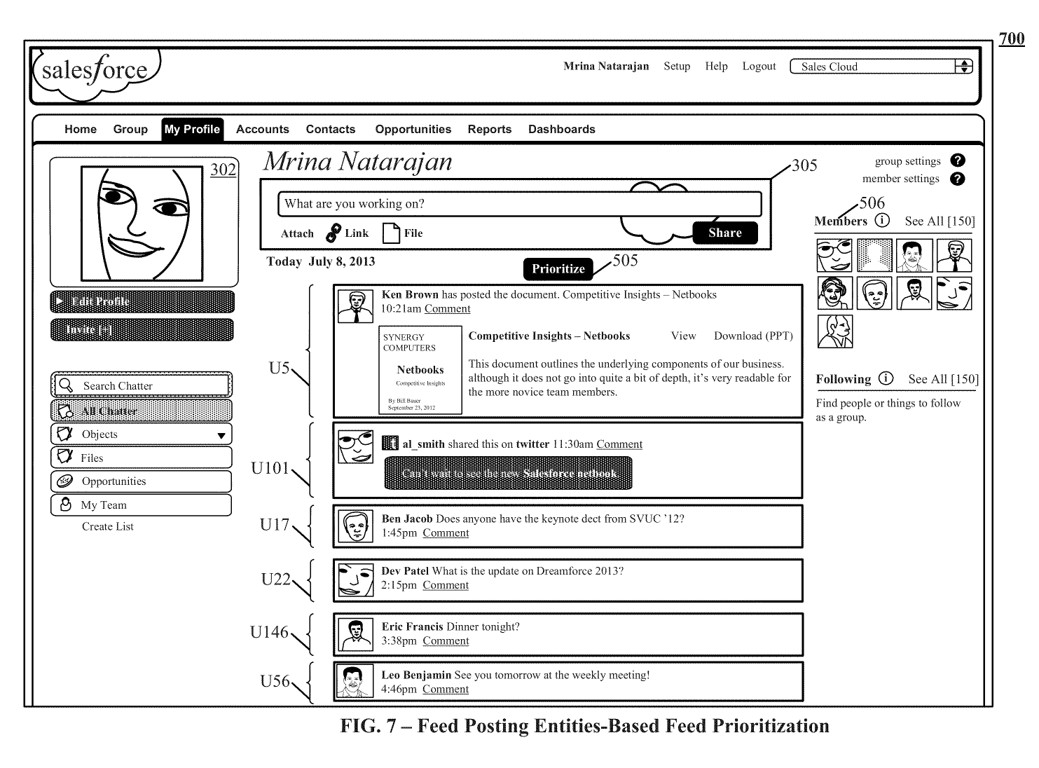

FIG. 7 illustrates one implementation of a feed posting entities-based customized view 700 for prioritizing content feeds based on feed posting entities. In particular, FIG. 7 presents a customized view 700 that includes a series of feeds prioritized based on the interaction metric table 670 and/or proximity metric table 680 described in the previous section “Feed Posting Entities-Based Records.” In some implementations, FIG. 7 illustrates an example social profile of feed receiving entity 302 “Mrina Natarajan” on an online social network such as Salesforce's Chatter. FIG. 7 also shows a target feed receiving entity 302 and feed posting entities U5, U101, U17, U22, U146, and U56. In other implementations, customized view 700 may not have the same screen objects or tabs as those listed above and/or may have other/different screen objects or tabs instead of, or in addition to, those listed above such as a social handle tabs, privacy tabs, groups tab, tag formats tabs, members tab, and the like.

In some implementations, feed receiving entity 302 can choose to prioritize a display of feed from feed posting entities 506 based on their levels of interaction and/or proximity with the feed receiving entity 302 so that higher rate feed items show up higher on a display. For example, feed receiving entity 302 can quickly identify feed items that are most important as those feed items can be displayed at a top of the feed. The order of the feed items can be based on an importance level (which can be determined by the database system using various factors, some of which are mentioned herein) and based on a rating from the feed receiving entity 302. In one implementation, the rating is on a scale that includes at least 3 values. In another implementation, the rating can be based on a binary scale.

According to some implementations, the display of feed can be prioritized based on feed posting entities 506 that are most interactive and/or proximate to the feed receiving entity 302 as specified in the interaction metric table 670 and/or proximity metric table 680. In other implementations, selecting a prioritize screen button 505 can prioritize the feeds based on the preferences of feed receiving entity 302. In some other implementations, feed receiving entity 302 can assign different importance or points to different actions performed by other users or members 506 to interact with the receiving entity 302. For instance, feed receiving entity 302 can choose to see higher on a display those feed items that include attached content such as documents mentioning the feed receiving entity 302. In another example, feed items from those users that mention the feed receiving entity 302 most often or post most messages on feed receiving entity's profile can be identified and ranked higher on a feed display metric. In yet another example, feed items from those other users or members 506 that are nearby the feed receiving entity's current geographic location can be displayed higher on the feed or view 700. In some implementations, feed receiving entity 302 can specify one or filters so that only selected feed item types that posted within a range of distance or window of time can be displayed in the feed.

In other implementations, feed receiving entity 302 can choose to prioritize its feed based on the levels of interaction and/or proximity of other users or members 506 in her online social network with itself Upon clicking the prioritize button 505, feed receiving entity 302 can be shown a list of other users that have interacted most and/or are closest to it during a window of time. In some implementations, this period of time can be specified by the feed receiving entity 302. As shown, feed items from other users U5, U101, U17, U22, U146, and U56 that talk with the feed receiving entity 302 in various ways on the online social network or are most proximate to it can be filtered out and displayed at the top of the view 700.

### Flowcharts

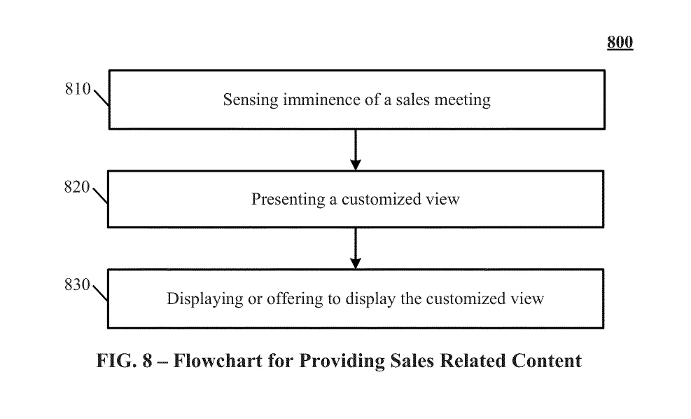

FIG. 8 is a flow chart 800 of one implementation for providing sales related content to a salesman for a sales meeting. Other implementations may perform the steps in different orders and/or with different, fewer or additional steps than the ones illustrated in FIG. 8. Multiple steps can be combined in some implementations. For convenience, this flowchart is described with reference to the system that carries out a method. The system is not necessarily part of the method.

The technology disclosed can sense an imminence of a sales meeting at step 810 by identifying a window of time scheduled for the sales meeting. In some implementations, imminence means closely proximate in time and/or location. In some implementations, the window of time can be identified by periodically checking a calendar and determining whether the sales meeting is within a pre-assigned threshold of time that specifies imminence of the sales meeting. In other implementations, it can sense imminence of the sales meeting by finding a coincidence of location between the sales meeting and the salesman. The coincidence of location can be found by periodically checking salesman's geographic location and determining whether the salesman is proximate to sales meeting's geographic location based on a pre-assigned threshold of proximity.

At step 820, the technology disclosed can present a customized view of a feed that automatically selects and moves to a prominent position in the customized view selected meeting-related content associated with a sales meeting and corresponding to a stage of a sales cycle. In some implementations, prominent means formatted to be at least partially visible or indicated flagged on the first screen of the customized view. In some other implementations, the meeting-related content can include at least common online social connections between the salesman and attendees at the sales meeting, marketing and legal documents required at the identified stage of the sales cycle, communication records between the salesman and attendees at the sales meeting, information related to other members of the salesman's sales team that are at least associated with the company or attendees at the sales meeting, and information related to other members of the salesman's sales team that are to be contacted at the end of the sales meetings. In other implementations, the meeting-related content can hold assembled information including at least recent news about an account or prospect at the sales meeting, standard account or prospect profile information and information linked to attendee profiles at the sales meeting. In yet other implementations, the feed can include individual directed messages, group directed messages and programmatically generated messages.

The technology disclosed can display or offer to display the customized view to the salesman with the selected meeting-related content during the identified window of time at step 830. In some implementations, the offer to display the customized view can be made by triggering an alert notification. In other implementations, the technology disclosed can provide a preview of the customized view that summarizes the selected meeting-related content associated with the sales meeting and corresponding to the stage of the sales cycle. In some other implementations, it can include receiving a set of display preferences from the salesman and filtering the customized view in accordance with the set of display preferences.

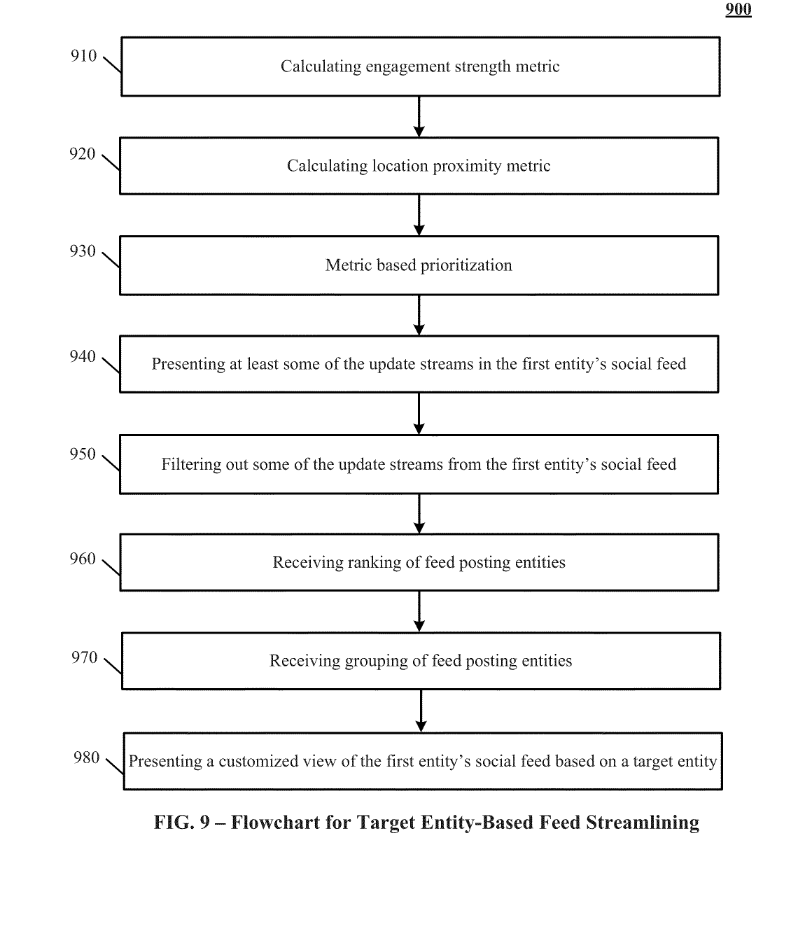

FIG. 9 is a flow chart 900 of one implementation for streamlining social feeds in an online social environment based on a target entity. Other implementations may perform the steps in different orders and/or with different, fewer or additional steps than the ones illustrated in FIG. 9. Multiple steps can be combined in some implementations. For convenience, this flowchart is described with reference to the system that carries out a method. The system is not necessarily part of the method.

At step 910, the technology disclosed can calculate an engagement strength metric of social connections between a target entity and a feed posting entity. In some implementations, the engagement strength metric can be calculated based on the message exchanges between the target entities and feed posting entities and entity mentions of target entity by the feed posting entities. Other examples of message exchanges can include posting feed items, making comments, mentions or replies, sharing pictures, etc. related to and/or with the target entity.

At step 920, the technology disclosed can calculate location proximity metric between a target entity and a feed posting entity. In some implementations, the location proximity metric can be calculated based on the geographic proximities between the target entity and the feed posting entity. In some implementations, when the target entity is an organization, the location reference can be the organizations' address stored in the location store 128.

The technology disclosed can then prioritize content feeds based on the engagement strength metric and/or location proximity metric at step 930. In some implementations, a feed can be rearranged such that feed items shared by those feed posting entities that engage with the target entity the most and/or are closest to the target entity's reference location can be moved to a prominent position in the feed. In other implementations, prioritization can based on other user preferences or prioritization criteria such as a windows of time, ranges of distance, entity types, message type, amounts of content shared in feed items, and type of content shared in feed items.

At step 940, the technology disclosed can present at least some of the feed items in the first entity's social feed. In some implementations, the prioritized feeds can be presented to a user such that these feeds can cover more than half of the display. In other implementations, these feed items can be highlighted and then displayed at the top of the feed to ensure their visibility.

The technology disclosed can filter out some of the feed items from the first entity's social feed at step 950. In some implementations, feed items that are ranked low on a metric (which determines prioritization of a) can be hidden from the user. In other implementations, users can view feed items with various metric values by specifying the corresponding metric values on a user-interface. In other implementations, users can hide feed items with various metric values by specifying the corresponding metric values on the user-interface. In some other implementations, the technology disclosed can divide an interface to concurrently display feed items with high, medium and low metric values.

At step 960, the technology disclosed can receive a ranking of the feed posting entities. In some implementations, the technology disclosed can allow users to customize the prioritization of feeds by providing a ranking of feed posting entities so that feed items originating from these entities are displayed to the user based on the ranking

At step 970, the technology disclosed can receive a grouping of the feed posting entities. In some implementations, the technology disclosed can allow users to customize the prioritization of feeds by providing a grouping of feed posting entities so that feed items originating from these entities are displayed. For instance, a user can choose to view feed items belonging to only certain members of his social network such as family members and avoid viewing of any feed items posted by his work colleagues.

The technology disclosed can present a customized view of the first entity's social feed based on the target entity at step 980. The customized view can be presented by rearranging a user's feed with feed items prioritized based one or more metrics. In some implementations, the customized view can be presented automatically when a certain trigger is registered. Examples of triggers can include timestamp-oriented triggers, location-oriented triggers, event-oriented triggers, etc.

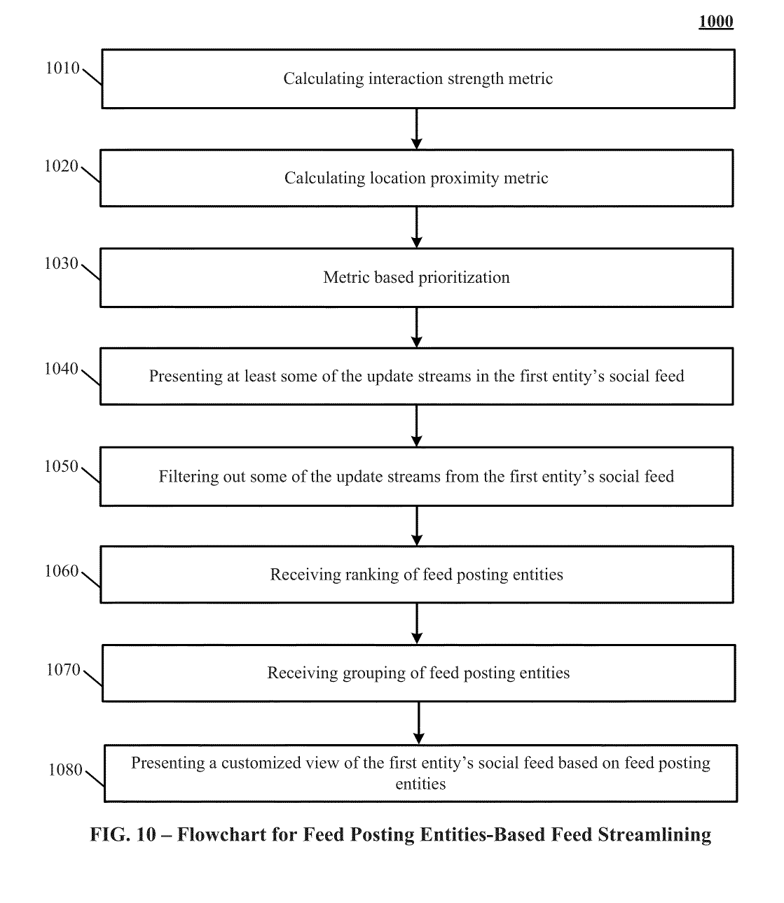

FIG. 10 is a flow chart 1000 of one implementation for streamlining social feeds in an online social environment based on feed posting entities. Other implementations may perform the steps in different orders and/or with different, fewer or additional steps than the ones illustrated in FIG. 10. Multiple steps can be combined in some implementations. For convenience, this flowchart is described with reference to the system that carries out a method. The system is not necessarily part of the method.

At step 1010, the technology disclosed can calculate interaction strength metric between a first entity and a feed posting entity. In some implementations, the interaction strength metric can be calculated based on the message exchanges between the first entity and feed posting entities. Other examples of message exchanges can include informational messages, status updates, group directed messages and programmatically generated messages.

At step 1020, the technology disclosed can calculate location proximity metric between the first entity and a feed posting entity. In some implementations, the location proximity metric can be calculated based on the geographic proximities between the first entity and the feed posting entity. In some implementations, when the first entity is an organization, the location reference can be the organizations' address stored in the location store 128.

The technology disclosed can then prioritize content feeds based on the interaction strength metric and/or location proximity metric at step 1030. In some implementations, a feed can be rearranged such that update streams shared by those feed posting entities that engage with the target entity the most and/or are closest to the target entity's reference location can be moved to a prominent position in the feed. In other implementations, prioritization can based on other user preferences or prioritization criteria such as a windows of time, ranges of distance, entity types, message type, amounts of content shared in update streams, and type of content shared in update streams.

At step 1040, the technology disclosed can present at least some of the update streams in the first entity's social feed. In some implementations, the prioritized feeds can be presented to a user such that these feeds can cover more than half of the display. In other implementations, these update streams can be highlighted and then displayed at the top of the feed to ensure their visibility.

The technology disclosed can filter out some of the update streams from the first entity's social feed at step 1050. In some implementations, update streams that are ranked low on a metric (which determines prioritization of a) can be hidden from the user. In other implementations, users can view update streams with various metric values by specifying the corresponding metric values on a user-interface. In other implementations, users can hide update streams with various metric values by specifying the corresponding metric values on the user-interface. In some other implementations, the technology disclosed can divide an interface to concurrently display update streams with high, medium and low metric values.

At step 1060, the technology disclosed can receive a ranking of the feed posting entities. In some implementations, the technology disclosed can allow users to customize the prioritization of feeds by providing a ranking of feed posting entities so that update streams originating from these entities are displayed to the user based on the ranking

At step 1070, the technology disclosed can receive a grouping of the feed posting entities. In some implementations, the technology disclosed can allow users to customize the prioritization of feeds by providing a grouping of feed posting entities so that update streams originating from these entities are displayed. For instance, a user can choose to view update streams belonging to only certain members of his social network such as family members and avoid viewing of any update streams posted by his work colleagues.

The technology disclosed can present a customized view of the first entity's social feed based on the feed posting entities at step 1080. The customized view can be presented by rearranging a user's feed with update streams prioritized based one or more metrics. In some implementations, the customized view can be presented automatically when a certain trigger is registered. Examples of triggers can include timestamp-oriented triggers, location-oriented triggers, event-oriented triggers, etc.

### Computer System

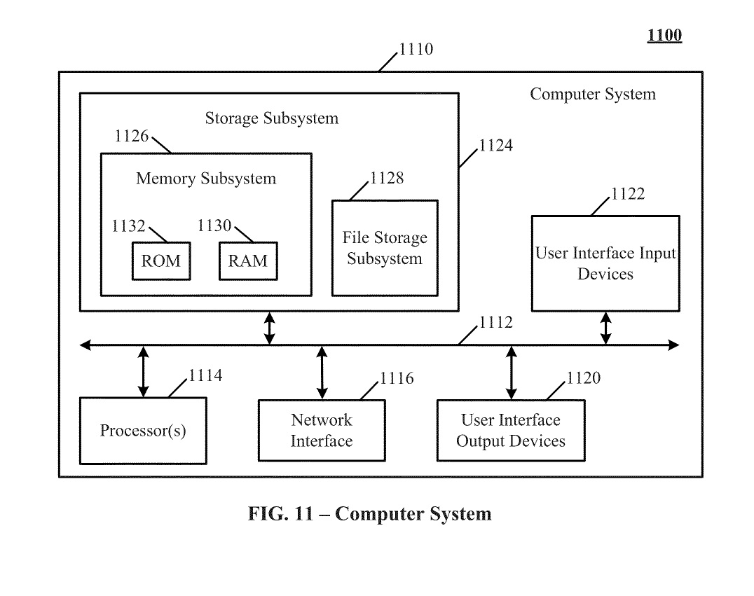

FIG. 11 is a block diagram of an example computer system 1100 for feed customization and streamlining. FIG. 11 is a block diagram of an example computer system, according to one implementation. Computer system 1110 typically includes at least one processor 1114 that communicates with a number of peripheral devices via bus subsystem 1112. These peripheral devices can include a storage subsystem 1124 including, for example, memory devices and a file storage subsystem, user interface input devices 1122, user interface output devices 1120, and a network interface subsystem 1116. The input and output devices allow user interaction with computer system 1110. Network interface subsystem 1116 provides an interface to outside networks, including an interface to corresponding interface devices in other computer systems.

User interface input devices 1122 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 1110.

User interface output devices 1120 can include a display subsystem, a printer, a fax machine, or non-visual displays such as audio output devices. The display subsystem can include a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 1110 to the user or to another machine or computer system.

Storage subsystem 1124 stores programming and data constructs that provide the functionality of some or all of the modules and methods described herein. These software modules are generally executed by processor 1114 alone or in combination with other processors.

Memory 1126 used in the storage subsystem can include a number of memories including a main random access memory (RAM) 1130 for storage of instructions and data during program execution and a read only memory (ROM) 1132 in which fixed instructions are stored. A file storage subsystem 1128 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 1128 in the storage subsystem 1124, or in other machines accessible by the processor.

Bus subsystem 1112 provides a mechanism for letting the various components and subsystems of computer system 1110 communicate with each other as intended.

Although bus subsystem 1112 is shown schematically as a single bus, alternative implementations of the bus subsystem can use multiple busses.

Computer system 1110 can be of varying types including a workstation, server, computing cluster, blade server, server farm, or any other data processing system or computing device. Due to the ever-changing nature of computers and networks, the description of computer system 1110 depicted in FIG. 11 is intended only as one example. Many other configurations of computer system 1110 are possible having more or fewer components than the computer system depicted in FIG. 11.

### Particular Implementations

In one implementation, the technology disclosed includes a method for providing sales related content to a salesman for a sales meeting. The method includes presenting a customized view of a feed in support of a sales meeting that automatically selects and moves to a prominent position in the customized view selected meeting-related content associated with a sales meeting and corresponding to a stage of a sales cycle. In some implementations, prominent means formatted to be at least partially visible or indicated flagged on the first screen of the customized view. It further includes automatically sensing imminence of the sales meeting and displaying or offering to display the customized view to a salesman with the selected meeting-related content. In some implementations, imminence means closely proximate in time and/or location.

This method and other implementations of the technology disclosed can each optionally include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations such as feed customization environment, event-based feed customization, target entity-based feed customization, feed posting entities-based feed customization, etc.

The method further includes the feed including individual directed messages, group directed messages and programmatically generated messages. It further includes sensing imminence of the sales meeting by identifying a window of time scheduled for the sales meeting. In some implementations, imminence means closely proximate in time and/or location. It includes the window of time being identified by periodically checking a calendar and determining whether the sales meeting is within a pre-assigned threshold of time that specifies imminence of the sales meeting. It also includes displaying or offering to display the customized view to the salesman with the selected meeting-related content during the identified window of time.

The method further includes sensing imminence of the sales meeting by finding a coincidence of location between the sales meeting and the salesman. In some implementations, imminence means closely proximate in time and/or location. It also includes the coincidence of location being found by periodically checking salesman's geographic location and determining whether the salesman is proximate to sales meeting's geographic location based on a pre-assigned threshold of proximity.

The method further includes the meeting-related content including at least common online social connections between the salesman and attendees at the sales meeting, marketing and legal documents required at the identified stage of the sales cycle, communication records between the salesman and attendees at the sales meeting, information related to other members of the salesman's sales team that are at least associated with the company or attendees at the sales meeting and information related to other members of the salesman's sales team that are to be contacted at the end of the sales meetings. It also includes the meeting-related content holding assembled information such as recent news about an account or prospect at the sales meeting, standard account or prospect profile information and information linked to attendee profiles at the sales meeting.

The method further includes offering to display the customized view by triggering an alert notification. It includes providing a preview of the customized view that summarizes the selected meeting-related content associated with the sales meeting and corresponding to the stage of the sales cycle. It also includes receiving a set of display preferences from the salesman and filtering the customized view in accordance with the set of display preferences.

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

In another implementation, a method is described for streamlining social feeds in an online social environment. The method includes presenting a customized view of a first entity's social feed that focuses on a target entity by prioritizing content in a first entity's social feed based on an engagement strength metric of social connections between the target entity and feed posting entities. It further includes calculating the engagement strength metric is based on at least quantities of message exchanges between the target entity and feed posting entities and entity mentions of target entity by the feed posting entities.

This method and other implementations of the technology disclosed can each optionally include one or more of the following features and/or features described in connection with additional methods disclosed.

The method further includes the social feed being within an online social environment and includes individually directed messages, group directed messages and programmatically generated messages.

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

In yet another implementation, the technology disclosed includes a method for streamlining social feeds in an online social environment. The method includes presenting a customized view of a first entity's social feed that prioritizes update streams of feed posting entities in a first entity's social feed based on an interaction strength metric of social connections between the first entity and the feed-posting entities. It further includes calculating the interaction strength metric based on at least quantities of message exchanges between the first entity and feed posting entities.

This method and other implementations of the technology disclosed can each optionally include one or more of the following features and/or features described in connection with additional methods disclosed.

The method further includes the social feed being within an online social environment. It also includes the update streams including informational messages, status updates, and group directed messages and programmatically generated messages.

The method further includes prioritizing update streams of feed posting entities in the first entity's social feed based on a location proximity metric of geographic proximities between the first entity and the feed-posting entities. It also includes presenting at least some of the update streams in the first entity's social feed ordered in accordance with at least the interaction strength metric and the location proximity metric and filtering out some of the update streams from the first entity's social feed responsive to at least the interaction strength metric and the location proximity metric.

The method further includes receiving from the first entity a ranking of feed posting entities that specifies an order of prioritization of update streams of feed posting entities in the first entity's social feed. It also includes receiving from the first entity a grouping of feed posting entities to provide group-based prioritization of update streams of feed posting entities in the first entity's social feed.

While the present invention is disclosed by reference to the preferred implementations and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

1. A method for providing sales related content to a salesman for a sales meeting, the method including:
in support of a sales meeting, presenting a customized view of a feed that automatically selects and moves to a prominent position in the customized view selected meeting-related content associated with a sales meeting and corresponding to a stage of a sales cycle; and
automatically sensing imminence of the sales meeting and displaying or offering to display the customized view to a salesman with the selected meeting-related content.

2. The method of claim 1, wherein the feed includes individual directed messages, group directed messages and programmatically generated messages.

3. The method of claim 1, further including sensing imminence of the sales meeting by identifying a window of time scheduled for the sales meeting.

4. The method of claim 3, wherein the window of time is identified by periodically checking a calendar and determining whether the sales meeting is within a pre-assigned threshold of time that specifies imminence of the sales meeting.

5. The method of claim 4, further including displaying or offering to display the customized view to the salesman with the selected meeting-related content during the identified window of time.

6. The method of claim 1, further including sensing imminence of the sales meeting by finding a coincidence of location between the sales meeting and the salesman.

7. The method of claim 6, wherein the coincidence of location is found by periodically checking salesman's geographic location and determining whether the salesman is proximate to sales meeting's geographic location based on a pre-assigned threshold of proximity.

8. The method of claim 1, wherein the meeting-related content includes at least:
common online social connections between the salesman and attendees at the sales meeting;
marketing and legal documents required at the identified stage of the sales cycle;
communication records between the salesman and attendees at the sales meeting;
information related to other members of the salesman's sales team that are at least associated with the company or attendees at the sales meeting; and
information related to other members of the salesman's sales team that are to be contacted at the end of the sales meetings.

9. The method of claim 1, wherein the meeting-related content holds assembled information including at least:
recent news about an account or prospect at the sales meeting;
standard account or prospect profile information; and
information linked to attendee profiles at the sales meeting.

10. The method of claim 1, further including offering to display the customized view by triggering an alert notification.

11. The method of claim 1, further including providing a preview of the customized view that summarizes the selected meeting-related content associated with the sales meeting and corresponding to the stage of the sales cycle.

12. The method of claim 1, further including receiving a set of display preferences from the salesman and filtering the customized view in accordance with the set of display preferences.

13. A method for streamlining social feeds in an online social environment, the method including:
presenting a customized view of a first entity's social feed that focuses on a target entity by prioritizing content in a first entity's social feed based on an engagement strength metric of social connections between the target entity and feed posting entities; and
wherein calculating the engagement strength metric is based on at least quantities of message exchanges between the target entity and feed posting entities and entity mentions of target entity by the feed posting entities.

14. The method of claim 13, wherein the social feed is within an online social environment and includes individually directed messages, group directed messages and programmatically generated messages.

15. A method for streamlining social feeds in an online social environment, the method including:
presenting a customized view of a first entity's social feed that prioritizes update streams of feed posting entities in a first entity's social feed based on an interaction strength metric of social connections between the first entity and the feed posting entities; and
wherein calculating the interaction strength metric is based on at least a quantity of message exchanges between the first entity and feed posting entities.

16. The method of claim 15, wherein the update streams are within an online social environment and include informational messages, status updates, group directed messages and programmatically generated messages.

17. The method of claim 15, further including prioritizing update streams of feed posting entities in the first entity's social feed based on a location proximity metric of geographic proximities between the first entity and the feed-posting entities.

18. The method of claim 17, further including:
ordered in accordance with at least the interaction strength metric and the location proximity metric, presenting at least some of the update streams in the first entity's social feed; and
filtering out some of the update streams from the first entity's social feed responsive to at least the interaction strength metric and the location proximity metric.

19. The method of claim 15, further including receiving from the first entity a ranking of feed posting entities that specifies an order of prioritization of update streams of feed posting entities in the first entity's social feed.

20. The method of claim 15, further including receiving from the first entity a grouping of feed posting entities to provide group-based prioritization of update streams of feed posting entities in the first entity's social feed.
